(19) United States
(12) Patent Application Publication
(10) Pub. No.: US 2026/0188292 A1
(43) Pub. Date: Jul. 2, 2026

(54) SOUND ZONES THAT CREATE QUIET ZONES

(71) Applicant: HARMAN INTERNATIONAL INDUSTRIES, INCORPORATED, Stamford, CT (US)

(72) Inventors: Tingli CAI, Ann Arbor, MI (US); Riley WINTON, Opelika, AL (US); Martin OLSEN, Struer (DK); Maxwell B. WILLIS, Detroit, MI (US); Sachin CHADHA, Farmington Hills, MI (US)

(21) Appl. No.: 19/005,905

(22) Filed: Dec. 30, 2024

(51) Int. Cl. G10K 11/178

(52) U.S. Cl. CPC G10K 11/17817; G10K 11/1787

(57) ABSTRACT

Various embodiments disclose techniques for generating one or more sound zones and a quiet zone in a listening environment. The techniques include configuring one or more filters of a filter bank, generating a respective speaker signal for each of one or more speakers by processing a respective audio zone signal for each of one or more sound zones using the filter bank, and outputting the respective speaker signals using the one or more speakers. Sound output by the one or more speakers propagates through a listening environment to generate respective sound in each of the one or more sound zones corresponding to the respective audio zone signal for that sound zone. The sound output by the one or more speakers propagates through the listening environment to generate a first quiet zone.

### BACKGROUND

### Field of the Various Embodiments

Embodiments of the present disclosure relate generally to audio systems and more specifically to techniques for generating sound zones that create quiet zones.

### Description of the Related Art

Current audio systems, such as audio systems in a vehicle, typically work to deliver uniform audio coverage throughout a listening environment, such as a cabin of a vehicle. Recent innovations have focused on generating sound zones in the listening environment, where different listeners can enjoy personalized audio experiences simultaneously with minimal interference or crosstalk from the audio experiences of other listeners. These approaches often rely on speaker architectures that control and direct audio to specific locations within the listening environment. For example, in a vehicle audio system, headrest or other speakers can be used to direct sound to an occupant seated in the seat or to direct sound to the occupant in the seat behind the headrest.

The audio systems can further use audio processing algorithms that configures filters that are designed to modify the audio emitted by each of the speakers to account for the likely crosstalk and carry over of the audio from one region/sound zone of the listening environment to another region/sound zone. Then the modified audio emitted from the various speakers the modified audio propagates through the listening environment to each of the regions/sound zones. At each of the regions/sound zones the modified audio from the various speakers constructively and/or destructively interferes so that only the desired audio is heard in the region/sound zone and the audio for the other regions/sound zones is muted or suppressed entirely.

While these conventional solutions have demonstrated that sound zones can be created and maintained for various types of audio content (e.g., music, phone calls, entertainment, navigation instructions, etc.), these conventional solutions have generally focused on presenting active audible signals rather than silence or quiet backgrounds. Conventional attempts to achieve quiet conditions inside a listening environment often involve crude methods such as muting or fading speakers. Such approaches, however, perform poorly due to the complex acoustics of most audio environments, resulting in insufficient isolation and audible leakage from other sound zones.

Accordingly, there is a need to improve techniques for generating sounds zones that include quiet zones.

### SUMMARY

Various embodiments disclose a computer-implemented method for generating one or more sound zones and a quiet zone in a listening environment. The computer-implemented method includes configuring one or more filters of a filter bank, generating a respective speaker signal for each of one or more speakers by processing a respective audio zone signal for each of one or more sound zones using the filter bank, and outputting the respective speaker signals using the one or more speakers. Sound output by the one or more speakers propagates through a listening environment to generate a respective sound in each of the one or more sound zones corresponding to the respective audio zone signal for that sound zone. The sound output by the one or more speakers propagates through the listening environment to generate a first quiet zone.

Further embodiments provide, among other things, one or more non-transitory computer-readable media and systems configured to implement the method set forth above.

At least one technical advantage of the disclosed approach relative to the prior art is that, with the disclosed techniques, users benefit from a more comfortable and flexible listening environment. In particular, the disclosed techniques mitigate unwanted external sounds such as audio from other sound zones to create a sound zone that is quiet or has a suitable background sound. In addition, the disclosed techniques are further able to reduce other sources of noise, such as road noise, engine noise, and the like. As a result, users enjoy greater privacy, improved relaxation, and enhanced personalization of their auditory experience. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a system configured to implement one or more aspects of the various embodiments;

FIG. 2 illustrates an example of sound zone generation in a listening environment, according to various embodiments;

FIG. 3 illustrates an example of sound zone and quiet zone generation in a listening environment, according to various embodiments;

FIG. 4 illustrates a vehicle-based audio system, according to various embodiments; and

FIG. 5 is a flow diagram of method steps for generating sound zones with quiet zones, according to various embodiments.

### DETAILED DESCRIPTION

In the following description, numerous specific details are set forth to provide a more thorough understanding of various embodiments. However, it will be apparent to those skilled in the art that the inventive concepts may be practiced without some or all of these specific details.

### Audio Processing System

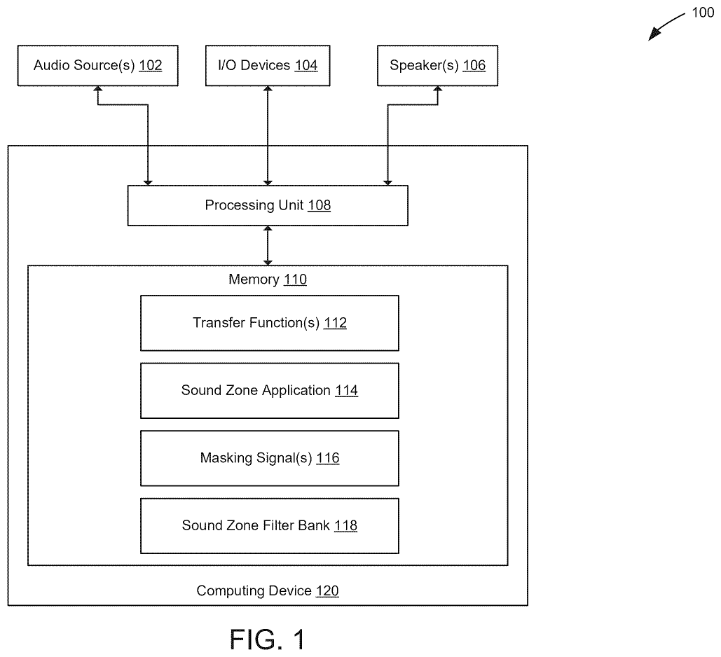

FIG. 1 is a schematic diagram illustrating an audio system 100 according to various embodiments. As shown, the audio system 100 includes, without limitation, one or more audio sources 102, one or more I/O devices 104, one or more speakers 106, and a computing device 120. The computing device 120 includes, without limitation, a processing unit 108 and memory 110. The memory 110 stores, without limitation, one or more transfer functions 112, a sound zone application 114, one or more masking signals 116, and a sound zone filter bank 118.

Computing device 120 is an audio processing device, such as a vehicle audio system, a home theater system, sound system, and/or similar system/device. In some embodiments, computing device 120 is included in one or more devices, such as consumer products (e.g., portable speakers, gaming consoles, entertainment systems, etc.), vehicles (e.g., the head unit of a car, truck, van, bus, train, airplane, etc.), smart home devices (e.g., smart lighting systems, security systems, digital assistants, etc.), communications systems (e.g., conference call systems, video conferencing systems, speaker amplification systems, etc.), mobile devices (e.g., smart phones, tablets, etc.), computers, and so forth. In some embodiments, computing device 120 is located in various acoustic environments including, without limitation, vehicles, indoor environments (e.g., living room, conference room, conference hall, home office, etc.), and/or outdoor environments, (e.g., patio, rooftop, garden, etc.). Computing device 120 is configured to receive audio content from the one or more audio sources 102 and output the audio content in order to generate sound and/or quiet zones in a listening environment.

The one or more audio sources 102 can include any technically feasible device or component capable of providing audio signals to computing device 120. For example, each of the one or more audio sources 102 can be an on-board media player, a streaming service accessed via a network connection, a media stream (e.g., from a cellular or smart telephone), or a storage device containing stored music, movie soundtracks, spoken word content, and/or other audio files. Each of the one or more audio sources 102 can adapt or switch content based on user preferences or selections, sensor input, system configurations, and/or the like.

The I/O devices 104 include any technically feasible kind of device and/or interfaces through which the audio system 100 can interact with the environment or users. The I/O devices 104 can be used to receive input and can include, without limitation, keyboards, knobs, buttons, sliders, touch screens, and/or the like. The I/O devices 104 can also be used to receive information from the environment and can include, without limitation, microphones, cameras, proximity sensors, or other input devices capable of detecting seat occupancy, background noise levels, and/or user commands. The I/O devices 104 can also include devices configured to provide output. For example, I/O devices 104 can include, without limitation, a display device (e.g., an LCD display, a heads-up display, etc.), haptic feedback elements and/or the like. I/O devices 104 can be used to present system information to one or more users and/or allow the one or more users to select from among different configuration settings. Additionally or alternatively, the I/O devices 104 can further include devices configured to both receive input and provide output, including, for example, a touchscreen and/or the like.

The one or more speakers 106 convert processed audio signals into audible sound for one or more users. Located within an environment, such as a vehicle cabin, sound output by the one or more speakers 106 generates the separate sound zones and quiet zones based on audio signals received from sound zone application 114. Certain speakers can be positioned close to listeners' heads (e.g., in headrests) or arranged in arrays to improve acoustic separation and minimize spillover between adjacent sound zones. Each of the one or more speakers 106 can be any technically feasible type of speaker.

Processing unit 108 controls the overall operation of computing device 120. Processing unit 108 is configured to read and write data from memory 110. Processing unit 108 can include any suitable hardware processor or combination of hardware processors, including one or more central processing units (CPUs), graphics processing units (GPUs), digital signal processors (DSPs), field-programmable gate arrays (FPGAs), or application-specific integrated circuits (ASICs), and/or any other type of processing unit, or a combination of processing units, such as a CPU configured to operate in conjunction with a GPU. In general, processing unit 108 can be any technically feasible hardware unit capable of processing data, executing instructions, and/or performing signal processing tasks, such as the signal processing task of sound zone application 114.

Memory 110 can include a random-access memory (RAM) module, a flash memory unit, or any other type of memory unit or combination thereof. The processing unit 108 is configured to read data from and write data to memory 110. In various embodiments, memory 110 includes non-volatile memory, such as optical drives, magnetic drives, flash drives, or other storage. In some embodiments, separate data stores, such as an external data stores (not shown) included in a network (“cloud storage”) can supplement the memory 110. The sound zone application 114 within memory 110 can be executed by the processing unit 108 to implement the overall functionality of the computing device 120 and, thus, to coordinate the operation of the audio system 100 as a whole. Memory 110 can further store data such as one or more of the one or more transfer functions 112, sound zone filter bank 118, and/or the one or more masking signals 116.

The one or more transfer functions 112 represent mathematical models that describe how sound output by speaker(s) 106 propagates through the listening environment and arrives at listening positions corresponding to the sound zones in the listening environment. The one or more transfer functions 112 enable sound zone application 114 to predict how audio output by the one or more speakers 106 will interact with the acoustics of the listening environment. By taking the one or more transfer functions 112 into account, sound zone application 114 configures sound zone filter bank 118 and/or one or more masking signals 116 so that desired audio content is accurately heard in the corresponding sounds zones and the desired quiet or masking signals 116 are heard in each of the corresponding quiet zones.

The sound zone application 114 controls the audio processing workflow, using data from I/O devices 104, configurations from one or more users to generate the desired sound zones and quiet zones. In operation, sound zone application 114 creates multiple sound zones within a listening environment, such as a vehicle cabin. Each sound zone can provide distinct audio content or, in some instances, very little to no audio to a user located in the corresponding sound zone. Sound zone application 114 manages how audio from the one or more audio sources 102 are directed, processed, and delivered to the one or more speakers 106.

The sound zone application 114 receives input from one or more users through a user interface. The user interface is displayed using a display device included in I/O devices 104. The user interface includes one or more menus, etc. to display configuration options. The user interface further receives selections, etc. from the one or more users. For example, a user can interact with a touchscreen, voice command interface, or physical controls of I/O devices 104 to choose one or more sound zones within the vehicle cabin and specify the audio content to be played in each sound zone. The user can select the audio content from among different types of content from the one or more audio sources 102 or designate one or more sound zones as a quiet zone. When establishing a quiet zone, the user can also indicate to use a masking signal (e.g., pink noise, white noise, no sound, relaxing sounds, stimulating sounds, synthetic masking sounds such as babble noise) and the volume level the masking signal 116 should be played. The same or different masking signals can be selected for different quiet zones. For example, a driver with a baby in car seat located in a second-row seat could designate the sound zone for that second-row seat as a quiet zone and then select and configure one of the one or more masking signals 116 that the driver knows is likely to sooth the baby.

Once the user has made selections for the configuration settings, sound zone application 114 uses the configuration settings and the one or more transfer functions 112 to configure sound zone filter bank 118. By integrating the configuration settings with the one or more transfer functions 112, sound zone application 114 computes or configures one or more filters in sound zone filter bank 118 to achieve the desired sound zone separation for the listening environment. For example, given a set of transfer functions C_{S,Z}(f) relating each speaker S to sound zone Z, and filter W_{S,Z}(f) to be determined, the system solves for values of W_{S,Z}(f) that yield a desired audio output Y_{Z}(f) for sound zone z (e.g., the audio selected for sound zone z by the user in the configuration settings) as indicated in Equation 1:

$${Y}_{z} ( f ) = {\sum }_{S} {C}_{S , Z} ( f ) \cdot [ {W}_{S , Z} ( f ) \cdot {X}_{Z} ( f ) ] \qquad Equation 1$$

Where X_{Z}(f) represents the desired sound for sound zone z. By solving Equation 1 for W_{S,Z}(f), sound zone application 114 obtains configuration settings for the filters in sound zone filter bank 118 that so that that Y_{z}(f) is approximately equal to X_{z}(f) and each sound zone receives the intended audio content (e.g., active music or other audio, minimized or muted signals for a quiet zone, or a masking signal). In addition, sound zone application 114 can make adjustments, such as a change in volume or frequency spectrum of X_{Z}(f), when X_{Z}(f) is a masking signal. This gives sound zone application 114 greater flexibility in configuring sound zone filter bank 118 to reduce the crosstalk in a first quiet zone due to audio from other sound zones in order to generate the desired masking sound in the first quiet zone.

Sound zone application 114 then filters each of the desired sound zone audio X_{Z}(f) using sound zone filter bank 118 to generate signals A_{S}=[W_{S,Z}(f)·X_{Z}(f)] for each of the one or more speakers 106. The signals A_{S}(f) are then sent to the respective speaker(s) 106 for output. Once output by the respective speaker 106, the audio corresponding to signals A_{S}(f) propagates to the various sound zones and is affected by the transfer functions C_{S,Z}(f) of the environment. After propagating to the sound zones, the audio combines and sounds Y_{Z}(f) are heard in the sound zones z.

In some embodiments, sound zone application 114 further adapts to changing environmental conditions. For example, a microphone (e.g., a microphone included in I/O devices 104) located in a particular sound zone can detect background noise (e.g., road noise, engine noise, conversational chatter, etc.), that is not part of the desired sound for that particular sound zone. In response, sound zone application 114 dynamically reconfigures sound zone filter bank 118 to reduce the background noise to improve the integrity of the sound in that particular sound zone This can involve adjusting the volume or frequency spectrum of the masking signals 116, altering volumes, or further refining the filters in sound zone filter bank 118 to enhance noise reduction or suppression. By continuously monitoring ambient conditions in the listening environment and adjusting accordingly, sound zone application 114 ensures that the sound in each sound zone remains stable and personalized over time.

Each of the one or more masking signals 116 corresponds to a desired sound to be heard in a quiet zone. For example, a masking signal 116 could be, without limitation, pink noise, white noise, no sound, relaxing sounds, stimulating sounds, synthetic masking sounds. Examples of relaxing sounds include, without limitation, leaves rustling, crashing waves, chirping birds, crackling fireplace, running water, and/or the like. Examples of stimulating sounds include, without limitation, urban environment sounds such as street chatter, laughter, distant music, rhythmic sounds, footsteps, and/or the like. Examples of synthetic masking sounds include, without limitation, babble noise, a mix of white and pink noise, and/or the like. When a masking signal 116 is no sound, the corresponding sound zone will be as quiet as possible. When a masking signal 116 is other than no sound, masking signal 116 is generated in the corresponding quiet zone to help suppress the audio in other sound zones or generate a soothing or relaxing sound in the corresponding quiet zone to enhance the perception of quietness by smoothing over low-level background noise or mild leakage from the other sound zones.

Sound zone filter bank 118 is a signal processing element configured to modify the audio signals based on parameters derived from transfer functions 112 and instructions from the sound zone application 114. Sound zone filter bank 118 includes one or more filters that, when configured by sound zone application 114 according to W_{S,Z}(f), generate the audio signals A_{S}(f) to be output by the one or more speakers 106.

### Sound Zone Generation

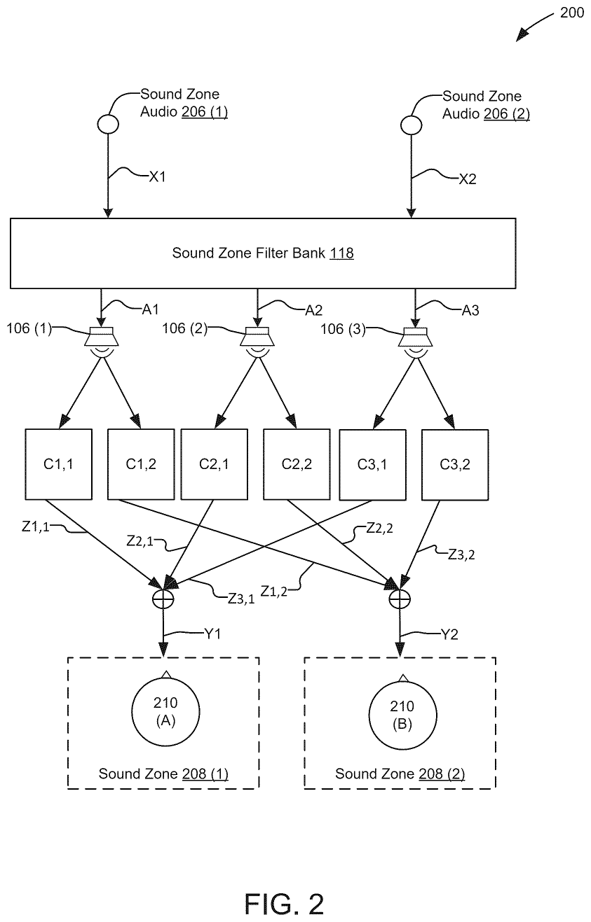

FIG. 2 illustrates an example of sound zone generation in an listening environment 200, according to various embodiments. As shown, listening environment 200 includes, without limitation, sound zones 208(1) and 208(2) in which listeners 210(A) and 210(B) are, respectively, located, and speakers 106(1)-106(3). And although listening environment 200 is shown with only two sound zones 208 and three speakers 106, this is not meant to be limiting. A listening environment could include more than two sound zones (e.g., three, four, five or more) and any number of speakers (e.g., two, four, five, or more). Further, although only one listener 210 is shown in each sound zone 208, any number of listeners (including none) could be located in each sound zone.

As further shown in FIG. 2, sound zone filter bank 118 receives sound zone audio 206(1) and 206(2). Sound zone audio 206(1) and 206(2) correspond to desired sounds X₁ and X₂, respectively, for sound zones 208(1) and 208(2). When configured by sound zone application 114 based on the solution to Equation 1, sound zone filter bank 118 filters sound zone audio 206(1) and 206(2) using the filters W_{s,z} to generate audio signals A₁, A₂, and A₃ for speakers 106(1), 106(2), and 106(3), respectively.

Speakers 106(1)-106(3) then output sound into listening environment 200 corresponding to audio signals A₁-A₃, respectively. The output sound propagates through the listening environment 200 and is affected by listening environment 200 according to the transfer functions C_{i,j}, where C_{i,j} corresponds to the way sound from speaker 106(i) is affected by the listening environment 200 before reaching sound zone 206(j). A sound Z_{i,j} generated by speaker 106(i) within sound zone 208(j) is Z_{i,j} according to Equation 2.

$${Z}_{i , j} = {C}_{i , j} \cdot {A}_{i} \qquad Equation 2$$

For example, when speaker 106(1) outputs sound based on audio signal A, listening environment 200 causes sound corresponding to Z_{1,2}=C_{1,2}·A₁ to reach sound zone 208(2). Similar effects occur for each of the other speaker 106(i) and sound zone 208(j) combinations. When each of the sounds Z_{i,j} reach a corresponding sound zone 208(j), the sounds Z_{i,j} combine (e.g., constructively or destructively) to generate sound Yⱼ for sound zone 208(j) according to Equation 3.

$${Y}_{j} = {\sum }_{i} {Z}_{i , j} \qquad Equation 3$$

When sound zone filter bank 118 is properly configured, Sound Yⱼ for each sound zone 208(j) should be substantially the same as sound zone audio 206(j)/Xⱼ. Thus, listener 210(A) in sound zone 208(1) should hear audio substantially the same as sound zone audio 206(1) while hearing little or no sound associated with sound zone audio 206(2). Similarly, listener 210(B) in sound zone 208(2) should hear audio substantially the same as sound zone audio 206(2) while hearing little or no sound associated with sound zone audio 206(1).

### Quiet Zone Generation

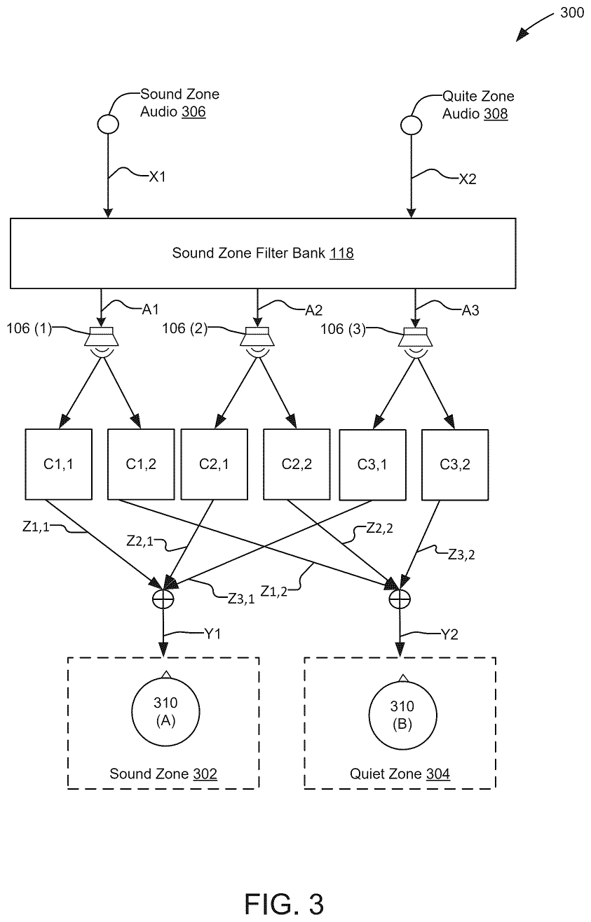

FIG. 3 illustrates an example of quite zone generation within a listening environment 300, according to various embodiments. As shown, listening environment 300 includes, without limitation, a sound zone 302, a quiet zone 304, and speakers 106(1)-106(3). Two listeners, 310(A) and 310(B), are located respectively, in sound zone 302 and quiet zone 304. Compared to the scenario in FIG. 2, sound zone audio 306 now corresponds to the main desired sound in sound zone 302, while quiet zone audio 308 corresponds to any optional or minimal audio presented to quiet zone 304.

As further shown in FIG. 3, sound zone filter bank 118 receives sound zone audio 306(1) and quiet zone audio 308. Sound zone audio 306 corresponds to desired sound X₁ for sound zone 302, and quiet zone audio 308 corresponds to desired quiet sound X₂, for quiet zone 304. When configured by sound zone application 114 based on the solution to Equation 1, sound zone filter bank 118 filters sound zone audio 306 and quiet zone audio 308 using the filters W_{s,z} to generate audio signals A₁, A₂, and A₃ for speakers 106(1), 106(2), and 106(3), respectively.

Speakers 106(1)-106(3) then output sound into listening environment 200 corresponding to audio signals A₁-A₃, respectively. The output sounds propagate through the listening environment 300 and are affected by listening environment 300 according to the transfer functions C_{i,j} and become sounds Z_{i,j} where the sounds Z_{i,j} combined to form the sounds Yⱼ.

When sound zone filter bank 118 is properly configured, Sound Y_{I} for sound zone 302 should be substantially the same as sound zone audio 306/X₁. Thus, listener 310(A) in sound zone 302 should hear audio substantially the same as sound zone audio 306 while hearing little or no other sounds. Sound Y₂ for quiet zone 304 should be substantially no sound or the masking signal 116 configures as sound zone audio 308/X₂. Thus, listener 310(B) in quiet zone 304 should hear substantially no audio or quiet zone audio 308 while hearing little or no sound associated with sound zone audio 306.

### Vehicle Audio System

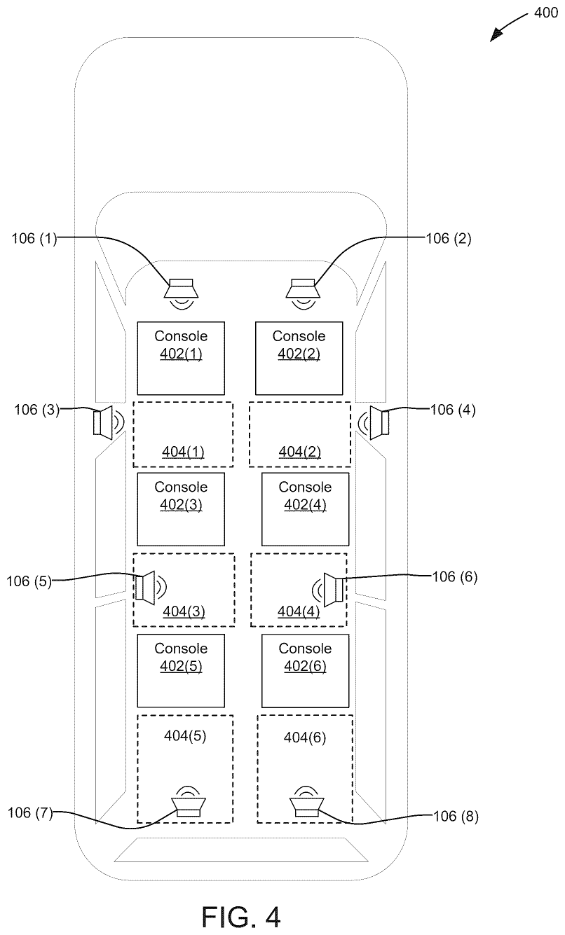

FIG. 4 illustrates a vehicle-based audio system for a vehicle 400, according to various embodiments. As shown, vehicle 400 includes without limitation, consoles 402 (e.g., consoles 401(2), 402(2), etc.), sound zones 404 (e.g., 404(1), 404(2), etc.), and speakers 106 (e.g., 106(1)-106(8). And although vehicle 400 is shown with six seats, six consoles 402, and eight speakers 106, this is exemplary only and not meant to be limiting. For example, a vehicle could have few or more seats, consoles, and/or speakers and/or seats, consoles, and/or speakers with a different arrangement.

As shown, vehicle 400 is configured with six sound zones 404(1)-404(6) corresponding to each of the seats that may or may not have an occupant. In some cases, each sound zone 404 corresponds to an individual seating position, such that each occupant's ears are located within the intended sound zone 404. For example, if an occupant in a front-row passenger seat is viewing media content on console 402(2), that occupant's ears are located within the boundaries of sound zone 404(2). Further, each of sound zones 404 can correspond to any of the sound zones or quiet zones described in FIGS. 1-3.

As further shown, consoles 402(1) and 402(2) are included on respective sides of a dashboard. Alternatively, consoles 402(1) and 402(2) could be combined in a single console, such as console for a head unit. Each of consoles 402(3)-402(6) is located in the backs of respective seats of vehicle 400. Each of the consoles 402(i) could be used by a respective seat occupant to control that occupant's own sound zone 404(i) by selecting an audio source for sound zone 404(i), selecting a quiet or a masking signal 116 for sound zone 404(i), controlling volume, and/or the like. In some embodiments, a console 402 could also be used to control other sound zones 404. For example, a driver could use console 402(1) to control sound zone 404(4) to select sounds for a child in sound zone 404(4), to select and configure a quiet or masking sound for baby in sound zone 402(4), and/or the like.

Speakers 106(1) and 106(2) are located on respective sides of the dashboard. Speaker 106(3) is located to a left of a front row (e.g., driver) seat, and speaker 106(4) is located to a right of the opposite front row seat. Speaker 106(5) is located in headrest of a left second row seat, and speaker 106(6) is located in a headrest of a right second row seat. Speakers 106(7) and 106(8) are located on respective sides of a rear/third row seats. Speakers 106(1)-106(8) could alternatively be located in other locations, such in the doors, pillars, ceiling, consoles, seat frames, and/or the like.

Generating Sound Zones with Quiet Zones

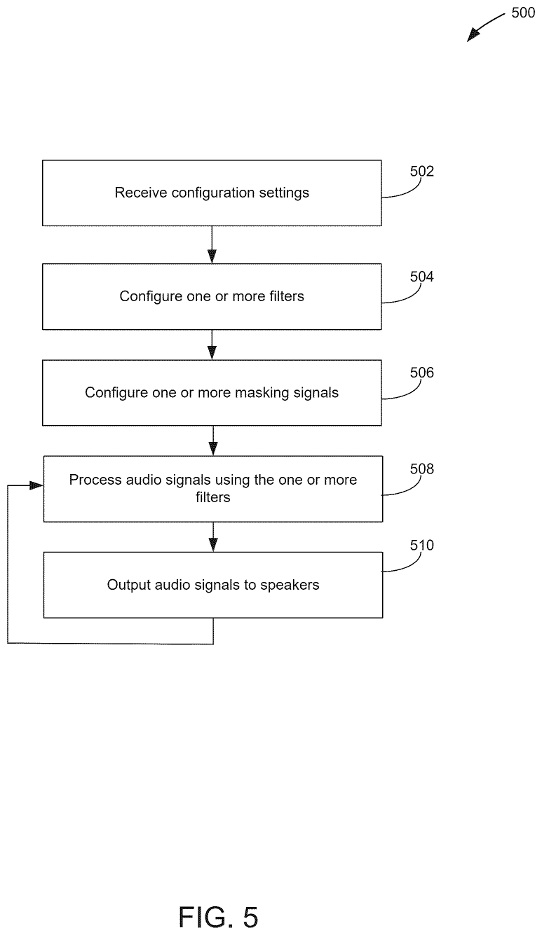

FIG. 5 illustrates a flow diagram of method steps for generating sound zones with quiet zones, according to various embodiments. Although the method steps are described with reference to the embodiments of FIGS. 1-4, persons skilled in the art will understand that any system configured to implement the method steps, in any order, falls within the scope of the present disclosure.

Method 500 begins at step 502, where sound zone application 114 receives configuration settings. For example, the configuration settings could be received via a user interface displayed to a user, such as by using I/O devices 104 and/or any of the consoles 402. The configuration settings include a selection of audio signals Xᵢ for each sound zone within a listening environment. The selected audio could be audio corresponding to sound zone audio 206, sound zone audio 306, and/or audio from any of the one or more audio sources. The configuration settings could also include audio settings, such as volume, equalization, and/or the like. In some examples, the configuration settings could further indicate that one or more of the sound zones is to be configured as a quiet zone in which no sound or sound corresponding to a masking signal 116 is to be heard. In such examples, the configuration settings could further include a selection of a masking signal 116, a volume of the masking signal 116, and/or the like. In some examples, the configuration settings could further include settings for noise suppression or cancelation for any of the sound zones.

At step 504, sound zone application 114 configures one or more filters. Based on the transfer functions C for the listening environment, sound zone application 114 configures the filters W of sound zone filter bank 118 based on the solution of Equation 1 in order to filter the sound zone audio, the quiet zone audio, and/or masking signals 116 specified in the configuration settings received in step 502 to compensate for the effects of the listening environment as modeled by the transfer functions C. In some embodiments, noise measurements from one or microphones in the listening environment can be used to measure noise in the various sound and quiet zones to further configure sound zone filter bank 118 to perform noise reduction or suppression in the sound zones and quiet zones.

At step 506, sound zone application 114 optionally configures the one or more masking signals 116. For example, sound zone application 114 can adjust one or more of a volume, a frequency spectrum, and/or the like of the one or more masking signals 116 in order to improve an ability of the one or more masking signals to mask the sound from other sound zones in a respective quiet zone. In some embodiments, the one or more masking signals 116 are further adjusted based on the noise measurements from the one or more microphones to further enhance the ability of sound zone application 114 and sound zone filter bank to reduce or suppress noise in the corresponding quiet zone.

At step 508, sound zone application 114 processes the one or more audio signals using the one or more filters. Sound zone application 114 uses the filters of sound zone filter bank 118 configured during step 504 to process the audio signals selected for each of the sound zones to generate audio signals to be output by the one or more speakers 106 of the audio system. This includes processing any of the one or masking signals 116, whether adjusted or not during optional step 506, using the filters of sound zone filter bank 118. After the one or more audio signals Xᵢ are processed by sound zone filter bank 118, signals Aᵢ for each of the speakers 106 are generated. including

At step 510, sound zone application 114 outputs the generated audio signals Aᵢ to one or more speakers 106. The one or more speakers 106 convert the audio signals Aᵢ which then propagate through the listening environment. The sound corresponding to each of the audio signals Aᵢ is transformed according to the transfer functions C as the sound propagates through the listening environment. When the sound from each of the one or more speakers 106 reaches the respective sound zones, the sounds are combined to form the sound heard in each of the sound zones. When sound zone filter bank 118 is configured properly, the desired sounds are heard in each of the sound zones and quiet and/or masking sounds are heard in each of the quiet zones with little to no crosstalk from the other sound zone and quiet zones. In addition, in embodiments where noise reduction or suppression is being used, the amount of noise in the various sound zones and quiet zones is reduced.

Method 500 then returns to step 508 where additional audio is processed for each of the sound zones and quiet zones in order to continue to generate the sound zones and quiet zones. Additionally, in cases where a user changes any of the configuration settings (e.g., to change the selection of the audio signals Xᵢ, to change audio settings, to change which sounds zones are quiet zones and/or the masking signals 116 of the quiet zones), method 500 returns to step 502.

In sum, a sound zone application generates a plurality of sound zones for a listening environment that includes one or more quiet zones. The sound zone application receives settings (e.g., from a user) designating which of the sound zones are designated as quiet zones with either quiet or with suitable masking audio. The sound zone application then configures one or more filters and one or more masking signals that generate audio signals to be output by one or more speakers. When the audio signals are output by the one or more speakers, the resulting audio generates the plurality of sound zones in the listening environment including the one or more quiet zones.

At least one technical advantage of the disclosed approach relative to the prior art is that, with the disclosed techniques, users benefit from a more comfortable and flexible listening environment. In particular, the disclosed techniques mitigate unwanted external sounds such as audio from other sound zones to create a sound zone that is quiet or has a suitable background sound. In addition, the disclosed techniques are further able to reduce other sources of noise, such as road noise, engine noise, and the like. As a result, users enjoy greater privacy, improved relaxation, and enhanced personalization of their auditory experience. These technical advantages provide one or more technological improvements over prior art approaches.
1. In some embodiments, a computer-implemented method for generating one or more sound zones and a quiet zone in a listening environment, the computer-implemented method comprises configuring one or more filters of a filter bank, generating a respective speaker signal for each of one or more speakers by processing a respective audio zone signal for each of one or more sound zones using the filter bank, and outputting the respective speaker signals using the one or more speakers, wherein sound output by the one or more speakers propagates through a listening environment to generate a respective sound in each of the one or more sound zones corresponding to the respective audio zone signal for that sound zone, and the sound output by the one or more speakers propagates through the listening environment to generate a first quiet zone.
2. The computer-implemented method of clause 1, wherein generating the respective speaker signals further comprising processing a masking signal using the filter bank, and the sound output by the one or more speakers propagates through the listening environment to generate sound corresponding to the masking signal in the first quiet zone.
3. The computer-implemented method of clauses 1 or 2, further comprising adjusting at least one of a volume or a frequency spectrum of the masking signal.
4. The computer-implemented method of any of clauses 1-3, wherein sound corresponding to the respective audio zone signals is not heard in the first quiet zone.
5. The computer-implemented method of any of clauses 1-4, further comprising measuring noise in the first quiet zone, and further configuring the one or more filters of the filter bank so that the sound output by the one or more speakers propagates through the listening environment to suppress the measured noise in the first quiet zone.
6. The computer-implemented method of any of clauses 1-5, further comprising receiving, from a user, a masking signal corresponding to sound to be heard in the first quiet zone.
7. The computer-implemented method of any of clauses 1-6, further comprising receiving, from the user, a volume level for the masking signal.
8. The computer-implemented method of any of clauses 1-7, wherein the masking signal is selected from a group consisting: of pink noise, white noise, no sound, a relaxing sound, a masking sound, and a stimulating sound.
9. The computer-implemented method of any of clauses 1-8, wherein the masking signal is selected from a group consisting of: leaves rustling, crashing waves, chirping birds, a crackling fireplace, running water; street chatter, laughter, distant music, rhythmic sounds, footsteps, babble noise, and a mix of white and pink noise.
10. The computer-implemented method of any of clauses 1-9, wherein the filter bank is further configured to process the audio signals to generate a second quiet zone in the listening environment.
11. The computer-implemented method of any of clauses 1-10, wherein sound corresponding to a first masking signal is heard in the first quiet zone and sound corresponding to a second masking signal is heard in the second quiet zone, the first masking signal being different from the second masking signal.
12. The computer-implemented method of any of clauses 1-11, wherein the listening environment is a cabin of a vehicle.
13. The computer-implemented method of any of clauses 1-12, wherein a console in the vehicle presents a user interface for configuring the one or more sound zones and the first quiet zone.
14. In some embodiments, one or more non-transitory computer-readable media store instructions that, when executed by one or more processors, cause the one or more processors to perform the steps of configuring one or more filters of a filter bank, generating a respective speaker signal for each of one or more speakers by processing a respective audio zone signal for each of one or more sound zones using the filter bank, and outputting the respective speaker signals using the one or more speakers, wherein sound output by the one or more speakers propagates through a listening environment to generate a respective sound in each of the one or more sound zones corresponding to the respective audio zone signal for that sound zone, and the sound output by the one or more speakers propagates through the listening environment to generate a first quiet zone.
15. The one or more non-transitory computer-readable media of clause 14, wherein generating the respective speaker signals further comprising processing a masking signal using the filter bank, and the sound output by the one or more speakers propagates through the listening environment to generate sound corresponding to the masking signal in the first quiet zone.
16. The one or more non-transitory computer-readable media of clauses 14 or 15, further comprising adjusting at least one of a volume or a frequency spectrum of the masking signal.
17. The one or more non-transitory computer-readable media of any of clauses 14-16, wherein the steps further comprise measuring noise in the first quiet zone, and further configuring the one or more filters of the filter bank so that the sound output by the one or more speakers propagates through the listening environment to suppress the measured noise in first quiet zone.
18. The one or more non-transitory computer-readable media of any of clauses 14-17, further comprising receiving, from a user, a masking signal corresponding to sound to be heard in the first quiet zone.
19. The one or more non-transitory computer-readable media of any of clauses 14-18, wherein the masking signal is selected from a group consisting: of pink noise, white noise, no sound, a relaxing sound, a masking sound, and a stimulating sound.
20. In some embodiments, a system comprises one or more speakers, a memory storing a sound zone application, and a processor coupled to the memory that executes the sound zone application by performing the steps of configuring one or more filters of a filter bank, generating a respective speaker signal for each of one or more speakers by processing a respective audio zone signal for each of one or more sound zones using the filter bank, outputting the respective speaker signals using the one or more speakers, wherein sound output by the one or more speakers propagates through a listening environment to generate a respective sound in each of the one or more sound zones corresponding to the respective audio zone signal for that sound zone, and the sound output by the one or more speakers propagates through the listening environment to generate a first quiet zone.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating one or more sound zones and a quiet zone in a listening environment, the computer-implemented method comprising:
configuring one or more filters of a filter bank;
generating a respective speaker signal for each of one or more speakers by processing a respective audio zone signal for each of one or more sound zones using the filter bank; and
outputting the respective speaker signals using the one or more speakers;
wherein:
sound output by the one or more speakers propagates through a listening environment to generate a respective sound in each of the one or more sound zones corresponding to the respective audio zone signal for that sound zone; and
the sound output by the one or more speakers propagates through the listening environment to generate a first quiet zone.

2. The computer-implemented method of claim 1, wherein:
generating the respective speaker signals further comprising processing a masking signal using the filter bank; and
the sound output by the one or more speakers propagates through the listening environment to generate sound corresponding to the masking signal in the first quiet zone.

3. The computer-implemented method of claim 2, further comprising adjusting at least one of a volume or a frequency spectrum of the masking signal.

4. The computer-implemented method of claim 1, wherein sound corresponding to the respective audio zone signals is not heard in the first quiet zone.

5. The computer-implemented method of claim 1, further comprising:
measuring noise in the first quiet zone; and
further configuring the one or more filters of the filter bank so that the sound output by the one or more speakers propagates through the listening environment to suppress the measured noise in the first quiet zone.

6. The computer-implemented method of claim 1, further comprising receiving, from a user, a masking signal corresponding to sound to be heard in the first quiet zone.

7. The computer-implemented method of claim 6, further comprising receiving, from the user, a volume level for the masking signal.

8. The computer-implemented method of claim 6, wherein the masking signal is selected from a group consisting: of pink noise, white noise, no sound, a relaxing sound, a masking sound, and a stimulating sound.

9. The computer-implemented method of claim 6, wherein the masking signal is selected from a group consisting of: leaves rustling, crashing waves, chirping birds, a crackling fireplace, running water; street chatter, laughter, distant music, rhythmic sounds, footsteps, babble noise, and a mix of white and pink noise.

10. The computer-implemented method of claim 1, wherein the filter bank is further configured to process the audio signals to generate a second quiet zone in the listening environment.

11. The computer-implemented method of claim 10, wherein sound corresponding to a first masking signal is heard in the first quiet zone and sound corresponding to a second masking signal is heard in the second quiet zone, the first masking signal being different from the second masking signal.

12. The computer-implemented method of claim 1, wherein the listening environment is a cabin of a vehicle.

13. The computer-implemented method of claim 12, wherein a console in the vehicle presents a user interface for configuring the one or more sound zones and the first quiet zone.

14. One or more non-transitory computer-readable media storing instructions that, when executed by one or more processors, cause the one or more processors to perform the steps of:
configuring one or more filters of a filter bank;
generating a respective speaker signal for each of one or more speakers by processing a respective audio zone signal for each of one or more sound zones using the filter bank; and
outputting the respective speaker signals using the one or more speakers;
wherein:
sound output by the one or more speakers propagates through a listening environment to generate a respective sound in each of the one or more sound zones corresponding to the respective audio zone signal for that sound zone; and
the sound output by the one or more speakers propagates through the listening environment to generate a first quiet zone.

15. The one or more non-transitory computer-readable media of claim 14, wherein:
generating the respective speaker signals further comprising processing a masking signal using the filter bank; and
the sound output by the one or more speakers propagates through the listening environment to generate sound corresponding to the masking signal in the first quiet zone.

16. The one or more non-transitory computer-readable media of claim 15, further comprising adjusting at least one of a volume or a frequency spectrum of the masking signal.

17. The one or more non-transitory computer-readable media of claim 14, wherein the steps further comprise:
measuring noise in the first quiet zone; and
further configuring the one or more filters of the filter bank so that the sound output by the one or more speakers propagates through the listening environment to suppress the measured noise in first quiet zone.

18. The one or more non-transitory computer-readable media of claim 14, further comprising receiving, from a user, a masking signal corresponding to sound to be heard in the first quiet zone.

19. The one or more non-transitory computer-readable media of claim 18, wherein the masking signal is selected from a group consisting: of pink noise, white noise, no sound, a relaxing sound, a masking sound, and a stimulating sound.

20. A system comprising:
one or more speakers;
a memory storing a sound zone application; and
a processor coupled to the memory that executes the sound zone application by performing the steps of:
configuring one or more filters of a filter bank;
generating a respective speaker signal for each of one or more speakers by processing a respective audio zone signal for each of one or more sound zones using the filter bank;
outputting the respective speaker signals using the one or more speakers;
wherein:
sound output by the one or more speakers propagates through a listening environment to generate a respective sound in each of the one or more sound zones corresponding to the respective audio zone signal for that sound zone; and
the sound output by the one or more speakers propagates through the listening environment to generate a first quiet zone.
